(19) United States
(12) Patent Application Publication
(10) Pub. No.: US 2024/0251878 A1
(43) Pub. Date: Aug. 1, 2024

(54) AEROSOL GENERATING DEVICE CAPABLE OF PROVIDING NOTIFICATION AND OPERATING METHOD THEREOF

(71) Applicant: KT&G CORPORATION, Daejeon (KR)

(72) Inventors: Yong Hwan KIM, Gyeonggi-do (KR); Dong Sung KIM, Seoul (KR); Hun ll LIM, Seoul (KR); Seok Su JANG, Daejeon (KR)

(73) Assignee: KT&G CORPORATION, Daejeon (KR)

(21) Appl. No.: 18/289,457

(22) PCT Filed: Dec. 1, 2022
(86) PCT No.: PCT/KR2022/019365

§ 371 Date: Nov. 3, 2023

(30) Foreign Application Priority Data
Dec. 17, 2021 (KR) 10-2021-0182206

(51) Int. Cl. A24F 40/60; A24F 40/46; A24F 40/51; A24F 40/53; A24F 40/65; A24F 40/90

(52) U.S. Cl. CPC A24F 40/60; A24F 40/46; A24F 40/51; A24F 40/53; A24F 40/65; A24F 40/90

(57) ABSTRACT

An aerosol generating device includes a heater configured to heat at least a part of an aerosol generating article, a memory, a user interface configured to output a notification to a user, and a processor electrically connected to the heater, the memory, and the user interface, wherein the processor is configured to, when an accumulated heating number of the heater is greater than or equal to a threshold value, obtain data about a heating time of the heater and store the obtained data in the memory, and output a notification through the user interface based on whether a preset condition regarding the data about the heating time is satisfied. In addition, various embodiments understood from the specification are possible.

### TECHNICAL FIELD

One or more embodiments according to the disclosure relate to an aerosol generating device configured to output a notification to a user based on data about a heating time and an operating method thereof.

### BACKGROUND ART

Recently, the demand for alternative methods to overcome the shortcomings of general cigarettes has increased. For example, there is increasing demand for a system for generating an aerosol by heating cigarettes or an aerosol generating material by using an aerosol generating device, rather than by burning cigarettes.

Specifically, an aerosol generating device may include a separate battery therein, and the battery may be a rechargeable secondary cell. When a user smokes using an aerosol generating device, a battery of the aerosol generating device may gradually be discharged, which leads to reduced usable time of the aerosol generating device.

### DISCLOSURE

### Technical Problem

Conventional aerosol generating devices display different colors of a light emitting diode (LED) status light according to the remaining battery power or show the remaining battery power on a display so that a user may check such indications and charge the aerosol generating device. However, when the battery is not charged at a proper time, the battery may be completely discharged, which may negatively affect the lifespan of the battery.

Accordingly, one or more embodiments of the disclosure provide an aerosol generating device configured to predict a proper time for charging based on data about heating time of a heater included therein and provide a notification to a user at the predicted time.

The technical problems to be solved by embodiments of the present disclosure are not limited to the aforementioned problems, and unmentioned technical problems may be clearly understood by one of ordinary skill in the art to which the embodiments pertain from the description and accompanying drawings.

### Technical Solution

According to an embodiment, an aerosol generating device includes a heater configured to heat at least a part of an aerosol generating article, a memory, a user interface configured to output a notification to a user, and a processor configured to, when an accumulated heating number of the heater is greater than or equal to a threshold value, obtain data about heating time of the heater and store the obtained data in the memory, and output a notification through the user interface based on whether a preset condition regarding the data about heating time is satisfied.

According to an embodiment, an operating method of an aerosol generating device includes, when an accumulated heating number of a heater is greater than or equal to a threshold value, obtaining data about heating time of the heater and storing the obtained data in a memory, and outputting a notification through a user interface based on whether a preset condition regarding the data about heating time is satisfied.

### Advantageous Effects

According to one or more embodiments of the disclosure, a proper timing for charging a battery of an aerosol generating device according to a smoking interval of a user may be predicted and notified to the user.

According to one or more embodiments of the disclosure, as the battery of the aerosol generating device is properly charged, the lifespan of the battery may be extended.

However, the effects according to one or embodiments are not limited to the effects described above, and unmentioned effects will be clearly understood by one of ordinary skill in the art from the present specification and the accompanying drawings.

### DESCRIPTION OF DRAWINGS

FIG. 1 is a block diagram of an aerosol generating device according to an embodiment.

FIG. 2 is a flowchart showing a process of obtaining data and outputting a notification by an aerosol generating device according to an embodiment.

FIG. 3 is a flowchart showing a specific process of obtaining data about a heating time by an aerosol generating device according to an embodiment.

FIG. 4 shows an example of data stored in a memory of an aerosol generating device according to an embodiment.

FIG. 5 is a flowchart showing a specific process of outputting a notification by an aerosol generating device according to an embodiment.

FIG. 6A shows an example of data stored in a memory of an aerosol generating device according to an embodiment.

FIG. 6B illustrates a first UI state displayed on a display of an aerosol generating device according to an embodiment.

FIG. 7A shows an example of data stored in a memory of an aerosol generating device according to an embodiment.

FIG. 7B illustrates a second UI state displayed on a display of an aerosol generating device according to an embodiment.

FIG. 8 is a block diagram of an aerosol generating device according to another embodiment.

### BEST MODE

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

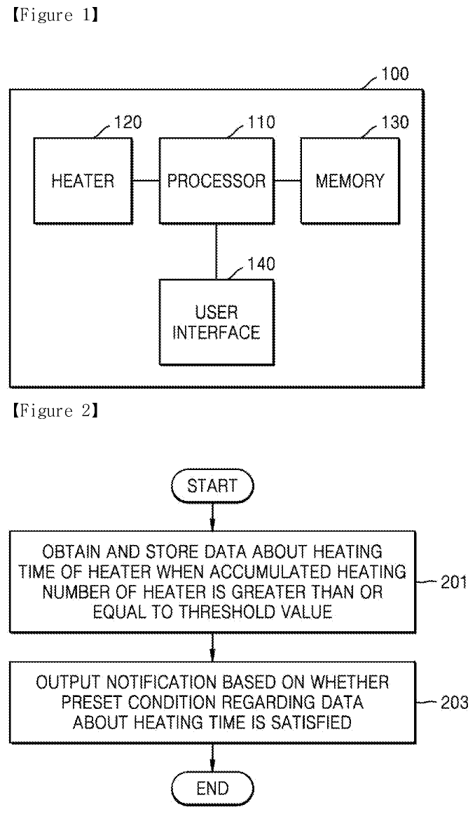

FIG. 1 is a block diagram of an aerosol generating device according to an embodiment.

With reference to FIG. 1, an aerosol generating device 100 may include a processor 110, a heater 120, a memory 130, and a user interface 140. However, the internal hardware components of the aerosol generating device 100 are not limited to the components illustrated in FIG. 1. It will be understood by one of ordinary skill in the art pertaining to the present embodiment that according to the design of the aerosol generating device 100, some of hardware components shown in FIG. 1 may be omitted, or an additional component may be further included.

Hereinafter, an operation of each of the components will be described without limiting locations of each component included in the aerosol generating device 100.

In an embodiment, the heater 120 may heat an aerosol generating article inserted into the aerosol generating device 100. For example, the heater 120 may receive power from a battery (not shown) under control of the processor 110 and heat at least a part of the aerosol generating article with the received power to generate an aerosol.

In an embodiment, the memory 130 may store various data processed in the aerosol generating device 100. For example, the memory 130 may store data processed or to be processed by the processor 110. The memory 130 may include various types of memories including random access memory (RAM), such as dynamic random access memory (DRAM) and static random access memory (SRAM), etc., read-only memory (ROM); electrically erasable programmable read-only memory (EEPROM), etc.

In an embodiment, the memory 130 may store data about heating time of the heater 120. For example, the data about heating time of the heater 120 may include an average heating interval of the heater 120 and a final heating time of the heater 120. In the disclosure, the “average heating interval” refers to an average interval between an end of heating by the heater 120 (i.e., a time point when power supply from the battery to the heater 120 is discontinued) and a restart of the heating by the heater 120 (i.e., a time point when the power supply from the battery to the heater 120 is initiated). Moreover, the “final heating time” refers to the latest time among time points when the heating by the heater 120 is initiated (i.e., the latest time point when the power supply from the battery to the heater 120 is initiated).

In an embodiment, the processor 110 control overall operations of the aerosol generating device 100.

In an embodiment, the processor 110 may obtain data from at least one component in the aerosol generating device 100 and control processes to be performed subsequently. For example, the processor 110 may obtain data from at least one sensor (e.g., a sensor configured to detect insertion of an aerosol generating article) and control power supplied to the heater 120 such that an operation of the heater 120 is initiated or terminated.

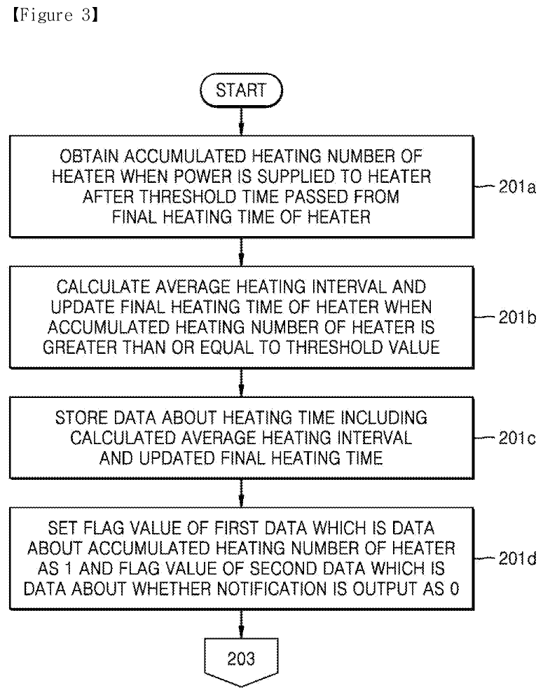

In an embodiment, the processor 110 may store data obtained from the components included in the aerosol generating device 100 in the memory 130. For example, when the accumulated heating number of the heater 120 satisfies a certain condition, the processor 110 may obtain data about the heating of the heater 120 from the heater 120 and store the obtained data in the memory 130. A detailed description thereon is given below with reference to FIG. 2.

In an embodiment, the processor 110 may initialize at least a part of the data stored in the memory 130 based on a reference unit time. For example, the processor 110 may initialize the data about the heating of the heater 120 stored in the memory 130 based on a reference unit time of 24 hours (i.e., 1 day).

In an embodiment, the processor 110 may output information about a state of the aerosol generating device 100 through the user interface 140 to the outside (e.g., a user). For example, the user interface 140 may include various interfacing devices such as a display or a lamp that outputs visual information, a motor that outputs tactile information, a speaker that outputs sound information, and input/output (I/O) interfacing units (for example, a button or a touch screen) that receive information input by a user or outputs information to the user, etc.

In an embodiment, when the data obtained from the components of the aerosol generating device 100 satisfies a certain condition, the processor 110 may output a notification through the user interface 140. For example, when the data about the heating of the heater 120 satisfies a certain condition, the processor 110 may output a notification through the user interface 140. A detailed description thereon is given below with reference to FIG. 2.

FIG. 2 is a flowchart showing a process of obtaining data and outputting a notification by an aerosol generating device according to an embodiment.

With reference to FIG. 2, in operation 201, when the accumulated heating number of a heater (e.g., the heater 120 of FIG. 1) is greater than or equal to a threshold value, a processor (e.g., the processor 110 of FIG. 1) may obtain data about heating time of the heater 120 and store the obtained data in a memory (e.g., the memory 130 of FIG. 1).

In the disclosure, the “accumulated heating number of the heater” refers to the number of heating of the heater 120 which has been counted since the charging of an aerosol generating device (e.g., the aerosol generating device 100 of FIG. 1) was recently terminated. For example, when a user performs a smoking operation five times through the aerosol generating device 100 after the charging of the aerosol generating device 100 is finished, the accumulated heating number of the heater 120 may be 5. Each smoking operation may include a serial of consecutive puffs.

For example, a threshold value of the accumulated heating number of the heater 120 may be set as 10. In this case, when the accumulated heating number of the heater 120 is 8, the processor 110 may not separately obtain data about heating time of the heater 120. However, when the accumulated heating number of the heater 120 is 11, the processor 110 may obtain the data about heating time of the heater 120 and store the obtained data in the memory 130.

In an embodiment, when the accumulated heating number of the heater 120 is greater than the threshold value, the processor 110 may obtain the average heating interval of the heater 120 and the final heating time of the heater 120. The average heating interval of the heater 120 may refer to an average of a plurality of heating intervals corresponding to the accumulated heating number excluding a maximum interval and a minimum interval. In addition, the average heating interval of the heater 120 may be obtained through a calculation operation of the processor 110. As the heater 120 may perform the calculation operation when the accumulated heating number of the heater 120 is greater than the threshold value, the burden of calculation requirement may be reduced, and the power consumption efficiency may also be improved.

According to an embodiment, in operation 203, the processor 110 may output a notification through a user interface (e.g., the user interface 140 of FIG. 1) based on whether a preset condition regarding the data about heating time of the heater 120 is satisfied.

In an embodiment, the preset condition regarding the data about heating time of the heater 120 may include a condition regarding the average heating interval of the heater 120. For example, the condition regarding the average heating interval of the heater 120 may be satisfied when the average heating interval calculated in operation 201 is less than a preset time (e.g., 240 minutes). The preset time may be set by a manufacturer or a user. Also, the preset time may be set automatically based on a smoking interval of a user.

In another embodiment, before determining whether the preset condition regarding the data about heating time of the heater 120 is satisfied, the processor 110 may first determine whether a condition regarding the data stored in the memory 130 is satisfied. For example, the condition regarding the data stored in the memory 130 is satisfied when, among the data flag values of the log data, the flag value of the first data regarding the accumulated heating number of the heater 120 is 1, and the flag value of the second data regarding the notification is 0. When the flog value of the first data is 1, the accumulated heating number of the heater 120 is greater than or equal to the threshold value. Also, when the flag value of the second data is 0, the notification through the user interface 140 is not output. However, such data expression method is not limited thereto, and may be changed in various forms according to a design.

In an embodiment, when the data about heating time of the heater 120 satisfies the preset condition, the processor 110 may output a notification through the user interface 140. The notification output through the user interface 140 may be about charging of the battery in the aerosol generating device 100. For example, when the data about heating time of the heater 120 satisfies the preset condition, the processor 110 may change the flag value of the second data regarding the notification stored in the memory 130 from 0 to 1. As the flag value of the second data is changed to 1, the processor 110 may output a notification through the user interface 140.

FIG. 3 is a flowchart showing a specific process of obtaining data about heating time by an aerosol generating device according to an embodiment. FIG. 3 is a flowchart to provide a detailed description of operation 201 of FIG. 2.

With reference to FIG. 3, when the power is supplied to a heater (e.g., the heater 120 of FIG. 1) after the threshold time has passed from the final heating time of the heater 120, in operation 201a, a processor (e.g., the processor 110 of FIG. 1) may obtain the accumulated heating number of the heater 120.

For example, when the threshold time is 10 minutes and the power is supplied to the heater 120 after the threshold time of 10 minutes has passed from when heating of the heater 120 was last initiated, the processor 110 may add 1 to the accumulated heating number of the heater 120. The threshold time refers to a maximum time interval which is considered by the processor 110 as continuous smoking. The threshold time may be set by a manufacturer or a user. Also, the preset time may be set automatically based on a smoking cycle of a user. That is, the processor 110 may count the heating operation of the heater 120 due to the user's continuous smoking towards the accumulated heating number of the heater 120.

According to an embodiment, in operation 201b, when the accumulated heating number of the heater 120 is greater than or equal to the threshold value, the processor 110 may calculate the average heating interval of the heater 120 and update the final heating time of the heater 120.

For example, when the threshold value is 10 and the accumulated heating number of the heater 120 is 11, the processor 110 may calculate the average heating interval of the heater 120. The processor 110 may calculate an average heating interval of 10 heating intervals including a time (T₁) between an end of a first heating and a start of a second heating, a time (T₂) between an end of the second heating and a start of a third heating, a time (T₃) between an end of the third heating and a start of a fourth heating, [symbol] , and a time (T₁₀) between an end of a tenth heating and a start of the final eleventh heating. In an embodiment, the processor 110 may calculate an average heating interval of eight heating intervals among the ten heating intervals, excluding the maximum value and the minimum value. In this case, the reliability of the average value of the heating intervals of the heater 120 may be increased.

Moreover, for example, when the threshold value is 10 and the accumulated heating number of the heater 120 is 11, the processor 110 may update the final heating time of the heater 120. Here, the updated final heating time may refer to the time point when the eleventh heating of the heater 120 is started.

According to an embodiment, in operation 201c, the processor 110 may store the data about heating time including the calculated average heating interval and the updated final heating time in a memory (e.g., the memory 130 of FIG. 1).

In an embodiment, the processor 110 may store the data about heating time in a data register of the memory 130. The data register of the memory 130 may refer to a register which remembers data to be used in subsequent calculations. For example, the processor 110 may set a parameter for the average heating interval as “INTERVAL_AVG” and store “INTERVAL_AVG=120 min” with respect to the calculated average heating interval in the data register of the memory 130. In addition, the processor 110 may set a parameter for the final heating time as “FINAL_HEAT” and store “FINAL_HEAT=11:30:01” with respect to the updated final heating time in the data register of the memory 130.

According to an embodiment, in operation 201d, the processor 110 may set the flag value of the first data, which is data about the accumulated heating number of the heater 120, as 1 and the flag value of the second data, which is data about whether a notification is output through a user interface (e.g., the user interface 140 of FIG. 1), as 0.

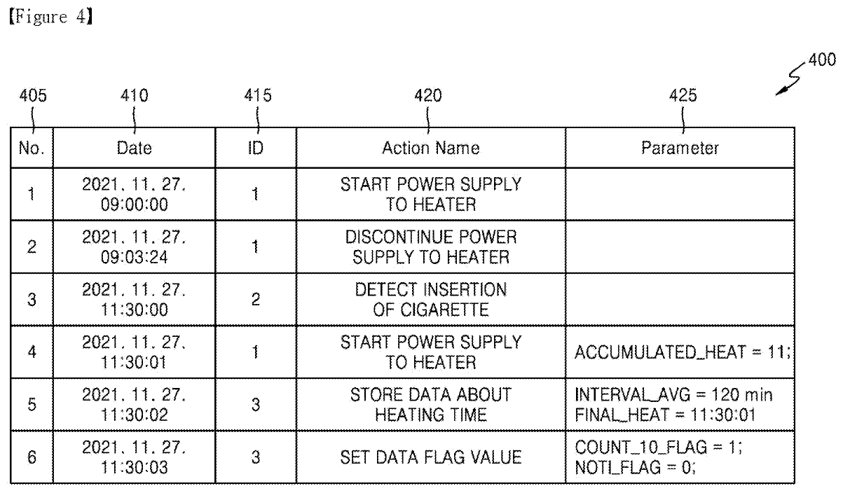

FIG. 4 shows an example of data stored in a memory of an aerosol generating device according to an embodiment. FIG. 4 illustrates a database format of an execution log of a processor (e.g., the processor 110 of FIG. 10) in an aerosol generating device (e.g., the aerosol generating device 100 of FIG. 1). However, the disclosure is not limited thereto.

With reference to FIG. 4, an execution log 400 of the processor 110 may include an entry number 405, a date 410, an identification (ID) 415 of a component, an action name 420 of a component and a parameter 425. However, this is merely an example, and the execution log 400 may include various fields within a scope obvious for a person skilled in the art.

In an embodiment, the log data 1 (i.e., data having entry number 1) may be data representing a start of power supply to a heater (e.g., the heater 120 of FIG. 1), and the log data 2 may be data representing a discontinuance of the power supply to the heater 120. The ID of the heater 120, which is a component of the aerosol generating device 100, may be 1. For example, the processor 110 may detect a start of power supply to the heater 120 from the battery at “2021. 11. 27. 09:00:00” and store the log data 1 in a memory (e.g., the memory 130 of FIG. 1). Then, the processor 110 may detect a discontinuance of the power supply to the heater 120 from the battery at “2021. 11. 27. 09:03:24” and store the log data 2 in the memory 130. Moreover, the processor 110 may determine that a final heating time is “2021. 11. 27. 09:00:00” at which the power supply to the heater 120 from the battery is started.

In an embodiment, the log data 3 may be data representing detection of insertion of a cigarette (i.e., an aerosol generating article) into the aerosol generating device 100. The ID of a cigarette recognition sensor (not shown), which is a component of the aerosol generating device 100, may be 2. For example, the processor 110 may detect insertion of a cigarette through the cigarette recognition sensor at “2021. 11. 27. 11:30:00” and store the log data 3 in the memory 130.

In an embodiment, the log data 4 may be data representing a start of power supply to the heater 120. The processor 110 may detect a start of power supply to the heater 120 from the battery at “2021. 11. 27. 11:30:01”. In addition, the processor 110 may detect the power supply to the heater 120 after the threshold time of 10 minutes has passed from the final heating time of “2021. 11. 27. 09:00:00”. Accordingly, the processor 110 may add 1 to the accumulated heating number and obtain the updated accumulated heating number (i.e., 11) of the heater 120. Then, the processor 110 may store “ACCUMULATED_HEAT=11” as a parameter for the accumulated heating number of the heater 120 in the memory 130.

In an embodiment, the log data 5 may be data representing storage of the data about heating time of the heater 120. The ID of the memory 130, which is a component of the aerosol generating device 100, may be 3. For example, at “2021. 11. 27. 11:30:02”, the processor 110 may calculate the average heating interval of the heater 120, update the final heating time of the heater 120, and store the same in the memory 130. For example, the processor 110 may store “INTERVAL_AVG=120 min” as a parameter for the average heating interval of the heater 120 and “FINAL_HEAT=11:30:01” as a parameter for the final heating time of the heater 120 in the memory 130.

In an embodiment, the log data 6 may be data representing setting and storage of a data flag value by the processor 110. For example, the processor 110 may set the flag value of the first data, which is data about the accumulated heating number of the heater 120, as 1 and the flag value of the second data, which is data about whether a notification is output through a user interface (e.g., the user interface 140 of FIG. 1), as 0. When the threshold value of the accumulated heating number of the heater 120 is 10, and the accumulated heating number is 11, the processor 110 may store “COUNT_10_FLAG=1” as a parameter for the first data flag in the memory 130. In addition, since a notification has not been output through the user interface 140, the processor 110 may store “NOTI_FLAG=0” as a parameter for the second data flag in the memory 130.

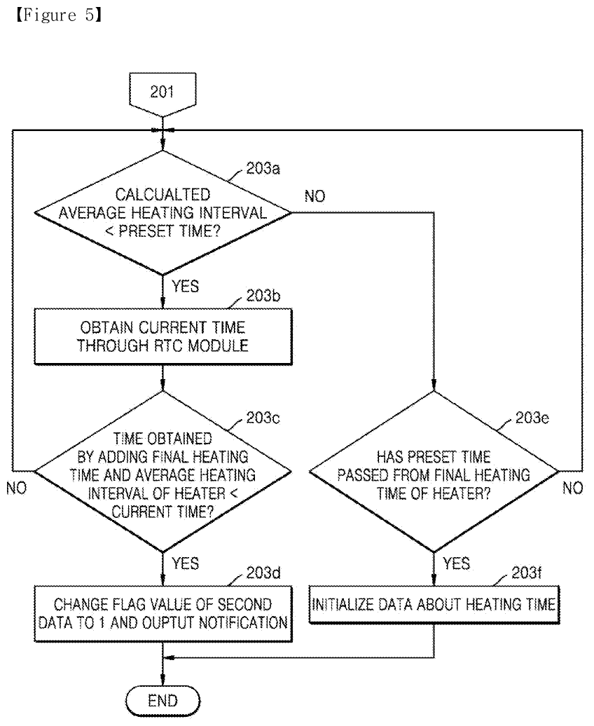

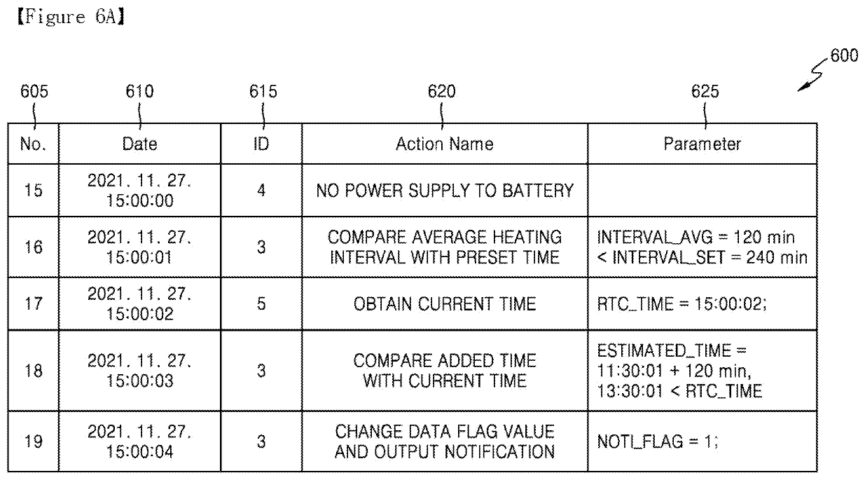

FIG. 5 is a flowchart showing a specific process of outputting a notification by an aerosol generating device according to an embodiment. FIG. 5 is a flowchart to provide a detailed description of operation 203 of FIG. 2.

With reference to FIG. 5, in operation 203a, a processor (e.g., the processor 110 of FIG. 1) may determine whether an average heating interval of a heater (e.g., the heater 120 of FIG. 1) is less than a preset time. For example, when the preset time is 240 minutes (i.e., 4 hours) and the average heating interval of the heater 120 calculated in operation 201b of FIG. 3 is 120 minutes (i.e., 2 hours) (i.e., when the user smokes at an average interval of 2 hours), the processor 110 may determine that the average heating interval of the heater 120 is less than the preset time.

In an embodiment, when it is determined that the average heating interval of the heater 120 is less than the preset time, the processor 110 may obtain a current time through a real time clock (RTC) module in operation 203b. For example, the processor 110 may obtain the current time of “2021. 11. 27. 15:00:02” through the RTC module.

In an embodiment, the processor 110 may compare the time obtained by adding the final heating time of the heater 120 and the average heating interval of the heater 120 with the current time obtained through the RTC module in operation 203c. For example, when the final heating time of the heater 120 updated in operation 201b of FIG. 3 is “2021. 11. 27. 11:30:01”, and the average heating interval of the heater 120 is 120 minutes, the processor 110 may obtain “2021. 11. 27. 13:30:01” by adding the final heating time of the heater 120 and the average heating interval of the heater 120.

In an embodiment, when it is determined that the time (e.g., “2021. 11. 27. 13:30:01”) obtained by adding the final heating time of the heater 120 and the average heating interval of the heater 120 is prior to the current time (e.g., “2021. 11. 27. 15:00:02”), the processor 110 may change the flag value of the second data to 1 and output a notification through a user interface (e.g., the user interface 140 of FIG. 1) in operation 203d.

On the other hand, when it is determined that the time obtained by adding the final heating time of the heater 120 and the average heating interval of the heater 120 is after the current time, the processor 110 may go back to operation 203a and repeat the subsequent operations.

In an embodiment, when the average heating interval of the heater 120 is determined to be greater than or equal to the preset time, the processor 110 may determine whether the preset time has passed from the final heating time of the heater 120 in operation 203e. For example, when the preset time is 240 minutes (i.e., 4 hours) and the average heating interval of the heater 120 is 270 minutes (i.e., 4.5 hours) (i.e., when the user smokes at an average interval of 4 hours and 30 minutes), the processor 110 may determine whether 4 hours has passed from the final heating time of “2021. 11. 27. 11:30:01.”

In an embodiment, when it is determined that the preset time has passed from the final heating time of the heater 120, the processor 110 may initialize the data about heating time of the heater 120 stored in the memory 130 in operation 203f. That is, when the user smokes at a frequency lower than the preset time, the processor 110 may not output a separate notification regarding the charging of the battery, and initialize the data about heating time of the heater 120 stored in the memory 130.

On the other hand, when it is determined that the preset time has not passed from the final heating time of the heater 120, the processor 110 may return to operation 203a and repeat the subsequent operations.

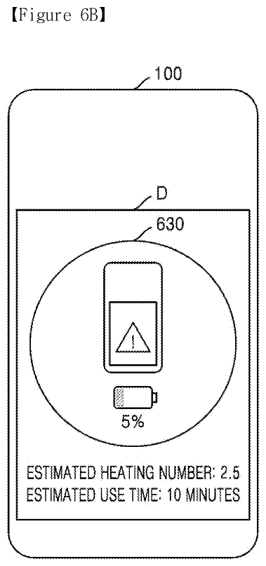

FIG. 6A shows an example of data stored in a memory of an aerosol generating device according to an embodiment. FIG. 6B illustrates a first UI state displayed on a display D of an aerosol generating device according to an embodiment.

With reference to FIG. 6A, an execution log 600 of the processor may include an entry number 605, a date 610 an identification (ID) 615 of a component, an action name 620 of a component and a parameter 625. However, this is merely an example, and the execution log 600 may include various fields within a scope obvious for a person skilled in the art.

In an embodiment, log data 15 may be data indicating that no power is supplied to the battery. An ID of the battery (not shown), which is a component of an aerosol generating device (e.g., the aerosol generating device 100 of FIG. 1), may be 4. For example, a processor (e.g., the processor 110 of FIG. 1) may detect that no power is supplied to the battery through terminals for receiving charging power, and may store the log data 15 in a memory (e.g., the memory 130 of FIG. 1).

In an embodiment, log data 16 may be data indicating that a result of comparing the average heating interval of the heater 120 with a preset time is obtained. For example, the processor 110 may compare “120 min” which is a value of “INTERVAL_AVG,” a parameter for the average heating number, with “240 min” which is a value of “INTERVAL_SET,” a parameter for the preset time. In addition, the processor 110 may determine that the average heating interval of the heater 120 is less than the preset time.

In an embodiment, the log data 17 may be data representing that the current time is obtained through the RTC module. The ID of the RTC module, which is a component of the aerosol generating device 100, may be 5. For example, the processor 110 may obtain “RTC_TIME=15:00:02” as a parameter for the current time from the RTC module.

In an embodiment, the log data 18 may be data representing that a result of comparing the time obtained by adding the final heating time of the heater 120 and the average heating interval of the heater 120 with the current time is obtained. For example, the processor 110 may add “FINAL_HEAT=11:30:01” representing the final heating time of the heater 120 to “INTERVAL_AVG=120 min” representing the average heating interval of the heater 120, and obtain “ESTIMATED_TIME=13:30:01” as a parameter for the estimated smoking time. Moreover, the processor 110 may compare “13:30:01” which is a value of “ESTIMATED_TIME,” which is a parameter for the estimated smoking time, with “15:00:02” which is a parameter for the current time. As a result, the processor 110 may determine that the estimated smoking time is prior to the current time.

In an embodiment, the log data 19 may be data representing that the flag value of the data stored in the memory 130 is changed by the processor 110 and a notification is output. For example, when it is determined that the estimated smoking time is prior to the current time, the processor 110 may change the flag value of the second data, which is data about the notification through a user interface (e.g., the user interface 140 of FIG. 1), to 1. The processor 110 may store “NOTI_FLAG=1” as a parameter for the second data flag in the memory 130 and output a notification through the user interface 140.

With reference to FIG. 6B, a user interface (UI) screen output through a display D of the aerosol generating device 100 may include at least one of an estimated heating number, an estimated use time, and a state of remaining battery power. The estimated heating number and the estimated use time may refer to an estimated remaining number of smoking operations and an estimated remaining time for heating of a cigarette, respectively, in consideration of a smoking interval of a user. For example, the UI screen output through the display D may display that the estimated heating number is 2.5 and the estimated heating time is 10 minutes.

Moreover, the UI screen may include an area 630 displaying a state of remaining battery power. For example, the area 630 may include a warning icon indicating that the aerosol generating device 100 needs to be charged, information about remaining battery power, and/or other icons.

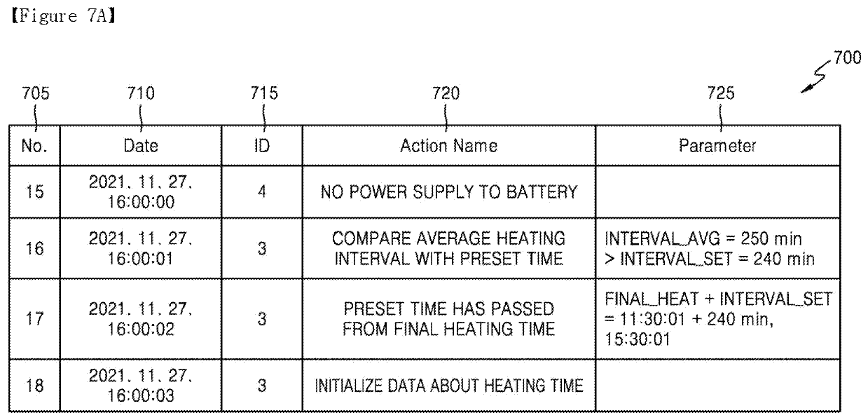

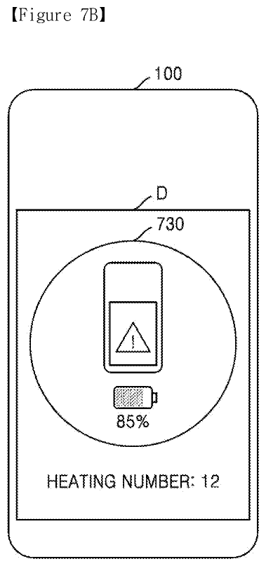

FIG. 7A shows an example of data stored in a memory of an aerosol generating device according to an embodiment. FIG. 7B illustrates a second UI state displayed on the display D of an aerosol generating device according to an embodiment.

With reference to FIG. 7A, an execution log 700 of the processor may include an entry number 705, a date 710, an identification (ID) 715 of a component, an action name 720 of a component and a parameter 725. However, this is merely an example, and the execution log 700 may include various fields within a scope obvious for a person skilled in the art.

In an embodiment, log data 15 may be data indicating that no power is supplied to the battery. An ID of the battery (not shown), which is a component of an aerosol generating device (e.g., the aerosol generating device 100 of FIG. 1), may be 4. For example, a processor (e.g., the processor 110 of FIG. 1) may detect that no power is supplied to the battery through terminals for receiving charging power, and may store the log data 15 in a memory (e.g., the memory 130 of FIG. 1).

In an embodiment, log data 16 may be data indicating that a result of comparing the average heating interval of the heater 120 with a preset time is obtained. For example, the processor 110 may compare “250 min” which is a value of “INTERVAL_AVG,” a parameter for the average heating number, with “240 min” which is a value of “INTERVAL_SET,” a parameter for the preset time. As a result, the processor 110 may determine that the average heating interval of the heater 120 is greater than the preset time.

In an embodiment, the log data 17 may be data representing that it is determined whether the preset time has passed from the final heating time of the heater 120. For example, the processor 110 may determine whether “INTERVAL_SET=240 min” representing the preset time has passed from “FINAL_HEAT=11:30:01” representing the final heating time of the heater 120.

In an embodiment, the log data 18 may be data representing initialization of the data about heating time of the heater 120. For example, when it is determined that the preset time (e.g., 240 minutes) has passed from the final heating time of the heater 120, the processor 110 may initialize the data about heating time of the heater 120.

With reference to FIG. 7B, a user interface (UI) screen output through a display D of the aerosol generating device 100 may include at least one of a heating number and a state of remaining battery power. The heating number may refer to an estimated remaining number for heating of a cigarette in consideration of the current remaining battery power. For example, the UI screen output through the display D may display that the current remaining battery power is 85% and the remaining heating number based on the remaining battery power is 12.

That is, the UI screen of FIG. 7B may be different from the UI screen of FIG. 6B in that the UI screen of FIG. 7B displays data which does not reflect user's smoking cycle. However, this is merely an example, and the UI screen of FIG. 7B may also display data reflecting the user's smoking cycle.

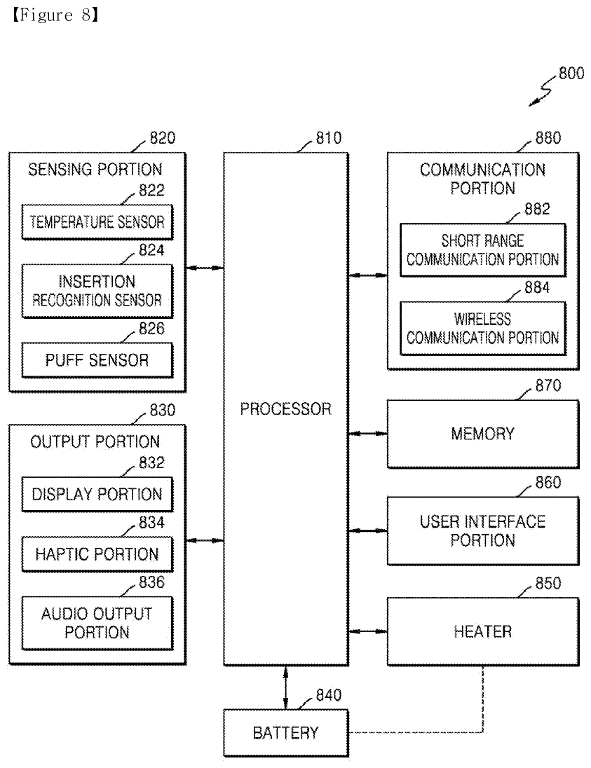

FIG. 8 is a block diagram of an aerosol generating device 800 according to another embodiment.

The aerosol generating device 800 may include a controller 810, a sensing unit 820, an output unit 830, a battery 840, a heater 850, a user input unit 860, a memory 870, and a communication unit 880. However, the internal structure of the aerosol generating device 800 is not limited to those illustrated in FIG. 8. That is, according to the design of the aerosol generating device 800, it will be understood by one of ordinary skill in the art that some of the components shown in FIG. 8 may be omitted or new components may be added.

The sensing unit 820 may sense a state of the aerosol generating device 800 and a state around the aerosol generating device 800, and transmit sensed information to the controller 810. Based on the sensed information, the controller 810 may control the aerosol generating device 800 to perform various functions, such as controlling an operation of the heater 850, limiting smoking, determining whether an aerosol generating article (e.g., a cigarette, a cartridge, or the like) is inserted, displaying a notification, or the like.

The sensing unit 820 may include at least one of a temperature sensor 822, an insertion detection sensor, and a puff sensor 826, but is not limited thereto.

The temperature sensor 822 may sense a temperature at which the heater 850 (or an aerosol generating material) is heated. The aerosol generating device 800 may include a separate temperature sensor for sensing the temperature of the heater 850, or the heater 850 may serve as a temperature sensor. Alternatively, the temperature sensor 822 may also be arranged around the battery 840 to monitor the temperature of the battery 840.

The insertion detection sensor 824 may sense insertion and/or removal of an aerosol generating article. For example, the insertion detection sensor 824 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 826 may sense a user's puff on the basis of various physical changes in an airflow passage or an airflow channel. For example, the puff sensor 826 may sense a user's puff on the basis of any one of a temperature change, a flow change, a voltage change, and a pressure change.

The sensing unit 820 may include, in addition to the temperature sensor 822, the insertion detection sensor 824, and the puff sensor 826 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 830 may output information on a state of the aerosol generating device 800 and provide the information to a user. The output unit 830 may include at least one of a display unit 832, a haptic unit 834, and a sound output unit 836, but is not limited thereto. When the display unit 832 and a touch pad form a layered structure to form a touch screen, the display unit 832 may also be used as an input device in addition to an output device.

The display unit 832 may visually provide information about the aerosol generating device 800 to the user. For example, information about the aerosol generating device 800 may mean various pieces of information, such as a charging/discharging state of the battery 840 of the aerosol generating device 800, a preheating state of the heater 850, an insertion/removal state of an aerosol generating article, or a state in which the use of the aerosol generating device 800 is restricted (e.g., sensing of an abnormal object), or the like, and the display unit 832 may output the information to the outside. The display unit 832 may be, for example, a liquid crystal display panel (LCD), an organic light-emitting diode (OLED) display panel, or the like. In addition, the display unit 832 may be in the form of a light-emitting diode (LED) light-emitting device.

The haptic unit 834 may tactilely provide information about the aerosol generating device 800 to the user by converting an electrical signal into a mechanical stimulus or an electrical stimulus. For example, the haptic unit 834 may include a motor, a piezoelectric element, or an electrical stimulation device.

The sound output unit 836 may audibly provide information about the aerosol generating device 800 to the user. For example, the sound output unit 836 may convert an electrical signal into a sound signal and output the same to the outside.

The battery 840 may supply power used to operate the aerosol generating device 800. The battery 840 may supply power such that the heater 850 may be heated. In addition, the battery 840 may supply power required for operations of other components (e.g., the sensing unit 820, the output unit 830, the user input unit 860, the memory 870, and the communication unit 880) in the aerosol generating device 800. The battery 840 may be a rechargeable battery or a disposable battery. For example, the battery 840 may be a lithium polymer (LiPoly) battery, but is not limited thereto.

The heater 850 may receive power from the battery 840 to heat an aerosol generating material. Although not illustrated in FIG. 8, the aerosol generating device 800 may further include a power conversion circuit (e.g., a direct current (DC)/DC converter) that converts power of the battery 840 and supplies the same to the heater 850. In addition, when the aerosol generating device 800 generates aerosols in an induction heating method, the aerosol generating device 800 may further include a DC/alternating current (AC) that converts DC power of the battery 840 into AC power.

The controller 810, the sensing unit 820, the output unit 830, the user input unit 860, the memory 870, and the communication unit 880 may each receive power from the battery 840 to perform a function. Although not illustrated in FIG. 8, the aerosol generating device 800 may further include a power conversion circuit that converts power of the battery 840 to supply the power to respective components, for example, a low dropout (LDO) circuit, or a voltage regulator circuit.

In an embodiment, the heater 850 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 850 may be implemented by a metal wire, a metal plate on which an electrically conductive track is arranged, a ceramic heating element, or the like, but is not limited thereto.

In another embodiment, the heater 850 may be a heater of an induction heating type. For example, the heater 850 may include a suspector that heats an aerosol generating material by generating heat through a magnetic field applied by a coil.

The user input unit 860 may receive information input from the user or may output information to the user. For example, the user input unit 860 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 8, the aerosol generating device 800 may further include a connection interface, such as a universal serial bus (USB) interface, and may connect to other external devices through the connection interface, such as the USB interface, to transmit and receive information, or to charge the battery 840.

The memory 870 is a hardware component that stores various types of data processed in the aerosol generating device 800, and may store data processed and data to be processed by the controller 810. The memory 870 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 870 may store an operation time of the aerosol generating device 800, the maximum number of puffs, the current number of puffs, at least one temperature profile, data on a user's smoking pattern, etc.

The communication unit 880 may include at least one component for communication with another electronic device. For example, the communication unit 880 may include a short-range wireless communication unit 882 and a wireless communication unit 884.

The short-range wireless communication unit 882 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 884 may include a cellular network communication unit, an Internet communication unit, a computer network (e.g., local area network (LAN) or wide area network (WAN)) communication unit, or the like, but is not limited thereto. The wireless communication unit 884 may also identify and authenticate the aerosol generating device 800 within a communication network by using subscriber information (e.g., International Mobile Subscriber Identifier (IMSI)).

The controller 810 may control general operations of the aerosol generating device 800. In an embodiment, the controller 810 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 810 may control the temperature of the heater 850 by controlling supply of power of the battery 840 to the heater 850. For example, the controller 810 may control power supply by controlling switching of a switching element between the battery 840 and the heater 850. In another example, a direct heating circuit may also control power supply to the heater 850 according to a control command of the controller 810.

The controller 810 may analyze a result sensed by the sensing unit 820 and control subsequent processes to be performed. For example, the controller 810 may control power supplied to the heater 850 to start or end an operation of the heater 850 on the basis of a result sensed by the sensing unit 820. As another example, the controller 810 may control, based on a result sensed by the sensing unit 820, an amount of power supplied to the heater 850 and the time the power is supplied, such that the heater 850 may be heated to a certain temperature or maintained at an appropriate temperature.

The controller 810 may control the output unit 830 on the basis of a result sensed by the sensing unit 820. For example, when the number of puffs counted through the puff sensor 826 reaches a preset number, the controller 810 may notify the user that the aerosol generating device 800 will soon be terminated through at least one of the display unit 832, the haptic unit 834, and the sound output unit 836.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a heater configured to heat at least a part of an aerosol generating article;
a memory;
a user interface configured to output a notification to a user; and
a processor configured to:
when an accumulated heating number of the heater is greater than or equal to a threshold value, obtain data about a heating time of the heater and store the obtained data in the memory; and
output the notification through the user interface based on whether a preset condition regarding the data about the heating time is satisfied.

2. The aerosol generating device of claim 1, wherein the processor is further configured to, after obtaining the data about the heating time, set a flag value of first data, which is data about the accumulated heating number of the heater, as 1, and set a flag value of second data, which is data about whether the notification is output through the user interface, as 0.

3. The aerosol generating device of claim 1, further comprising a battery configured to provide power to the heater,
wherein the processor is further configured to, when the battery begins supply of power to the heater after a threshold time has passed from a final heating time of the heater, increase the accumulated heating number.

4. The aerosol generating device of claim 1, wherein the processor is further configured to, when the accumulated heating number of the heater is greater than or equal to the threshold value, calculate an average heating interval between an end of previous heating of the heater and a start of next heating of the heater, update a final heating time of the heater, and store the data about the heating time including the calculated average heating interval and the updated final heating time in the memory.

5. The aerosol generating device of claim 4, further comprising a real time clock (RTC) module,
wherein the processor is further configured to, when the calculated average heating interval is less than a preset time, obtain a current time through the RTC module, and when an estimated smoking time obtained by adding the calculated average heating interval to the final heating time of the heater is before the current time, change a flag value of second data, which is data about whether a notification is output through the user interface, to 1.

6. The aerosol generating device of claim 5, wherein the processor is further configured to output the notification based on the changed flag value of the second data, and
wherein the notification indicates at least one of an estimated remaining heating number, an estimated remaining use time, and a state of remaining battery power.

7. The aerosol generating device of claim 4, wherein the processor is further configured to, when the calculated average heating interval is greater than or equal to a preset time and the preset time has passed from the final heating time of the heater, initialize the data about the heating time stored in the memory.

8. The aerosol generating device of claim 1, wherein the processor is further configured to initialize the data about heating time of the heater stored in the memory based on a reference unit time.

9. An operating method of an aerosol generating device, the operating method comprising:
when an accumulated heating number of a heater is greater than or equal to a threshold value, obtaining data about a heating time of the heater and storing the obtained data in a memory; and
outputting a notification through a user interface based on whether a preset condition regarding the data about the heating time is satisfied.

10. The operating method of claim 9, further comprising, after obtaining the data about the heating time, setting a flag value of first data about the accumulated heating number of the heater as 1 and setting a flag value of second data, which is data about whether the notification is output through the user interface, as 0.

11. The operating method of claim 9, further comprising, when a battery begins supply of power to the heater after a threshold time has passed from a final heating time of the heater, increasing the accumulated heating number.

12. The operating method of claim 9, further comprising:
when the accumulated heating number of the heater is greater than or equal to the threshold value, calculating an average heating interval between an end of previous heating of the heater and a start of next heating of the heater, and updating a final heating time of the heater; and
storing the data about heating time including the calculated average heating interval and the updated final heating time in the memory.

13. The operating method of claim 12, comprising:
when the calculated average heating interval is less than a preset time, obtaining a current time through a real time clock (RTC) module; and
when an estimated smoking time obtained by adding the calculated average heating interval to the final heating time of the heater is before the current time, changing a flag value of second data, which is data about whether a notification is output through the user interface, to 1.

14. The operating method of claim 13, further comprising outputting the notification based on the changed flag value of the second data,
wherein the notification indicates at least one of an estimated remaining heating number, an estimated remaining use time, and a state of remaining battery power.

15. The operating method of claim 12, further comprising, when the calculated average heating interval is greater than or equal to a preset time and the preset time has passed from the final heating time of the heater, initializing the data about the heating time stored in the memory and outputting the notification about at least one of an estimated remaining heating number and an estimated remaining use time.
